(19) United States
(12) Patent Application Publication
(10) Pub. No.: US 2008/0204946 A1
(43) Pub. Date: Aug. 28, 2008

(54) MAGNETORESISTANCE EFFECT ELEMENT AND MAGNETIC MEMORY DEVICE

(75) Inventors: Takao OCHIAI, Kawasaki (JP); Hiroshi ASHIDA, Kawasaki (JP); Takahiro IBUSUKI, Kawasaki (JP); Yutaka SHIMIZU, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/037,366

(22) Filed: Feb. 26, 2008

(30) Foreign Application Priority Data
Feb. 27, 2007 (JP) 2007-046666

(51) Int. Cl. G11B 5/33

(52) U.S. Cl. 360/324.12

(57) ABSTRACT

A magnetoresistance effect element having a free magnetic layer is provided. The free magnetic layer is formed in a laminate including a fixed magnetization layer having a fixed magnetization direction, a non-magnetic layer formed on the fixed magnetization layer, a first ferromagnetic layer, a non-magnetic metallic layer formed on the first ferromagnetic layer, and a second ferromagnetic layer formed on the non-magnetic metallic layer. The free magnetic layer includes magnetic recording regions, and in each region, the first ferromagnetic layer and the second ferromagnetic layer are coupled such that their magnetization directions are anti-parallel with each other, and one of the magnetic recording regions is opposite to the fixed magnetization layer with the non-magnetic layer therebetween.

### BACKGROUND OF THE INVENTION

1. Field of the Invention

The present invention relates to a magnetoresistance effect element and a magnetic memory device.

2. Description of the Related Art

In recent year, as rewritable nonvolatile memories, magnetic random access memories (hereinafter, referred to as MRAM) that have magnetoresistance effect elements arranged in matrix have been noted. In the MRAMs, information is stored using a combination of magnetization directions in two magnetic layers. The stored information is read out by detecting changes in resistances (that is, current changes or voltage changes) between in a case where the magnetization directions of two magnetic layers are parallel with each other and in a case in which the magnetization directions of two magnetic layers are anti-parallel with each other.

As the magnetoresistance effect elements forming the MRAMs, giant magnetoresistive (GMR) elements and tunneling magnetoresistive (TMR) elements have been known. Especially, the TMR elements that can obtain large resistance change have been expected for use as the magnetoresistance effect element for the MRAMs. The TMR element includes two ferromagnetic layers laid one on another with a tunnel insulation film formed therebetween and utilizes a phenomenon that a tunnel current flowing between the magnetic layers via the tunnel insulation film changes depending on relationships of magnetization directions of the two ferromagnetic layers. That is, the TMR element has low element resistance in a case where the magnetization directions of the two ferromagnetic layers are parallel with each other and has high element resistance in a case where the magnetization directions are anti-parallel with each other. These two states are related to data “0” and data “1” to thereby use the TMR element as a memory device.

Moreover, in recent years, magnetic memory devices that utilize a magnetic domain wall displacement phenomenon and magnetoresistance effect in fine wire type ferromagnetic layers have been proposed. Such magnetic memory devices have been disclosed, for example, in Japanese Unexamined Patent Application Publication No. 2006-073930 and U.S. Pat. No. 6,834,005.

In order to realize commercialization of a novel storage memory, it is necessary to develop a device whose performance is superior to existing DRAMs and flash memories.

However, the conventional magnetic memory devices utilizing the magnetic domain wall displacement phenomenon and the magnetoresistance effect in the fine wire type ferromagnetic layers have not attained enough magnetic domain wall displacement speeds, and it has not been possible to realize operation speeds comparable to those in the DRAMs and the flash memories.

The inventors of the present invention performed an examination that under a condition of a pulse width of 5 μsec and an application current of 5 mA, a voltage pulse is applied on a permalloy wire of 220 nm in width, and a result of a displacement speed of magnetic domain walls of 3 m/sec was obtained. The value corresponds to about 4 megabytes/sec in a data transfer speed, and less or equal to one tenth of a data transfer speed of current hard disk devices.

Accordingly, to realize the magnetic memory device utilizing the magnetic domain wall displacement phenomenon, it is necessary to increase the magnetic domain wall displacement speed.

### SUMMARY

According to an aspect of an embodiment, a magnetoresistance effect element having a free magnetic layer is provided. The free magnetic layer is formed in a laminate including a fixed magnetization layer having a fixed magnetization direction, a non-magnetic layer formed on the fixed magnetization layer, a first ferromagnetic layer, a non-magnetic metallic layer formed on the first ferromagnetic layer, and a second ferromagnetic layer formed on the non-magnetic metallic layer. The free magnetic layer includes magnetic recording regions, and in each region, the first ferromagnetic layer and the second ferromagnetic layer are coupled such that their magnetization directions are anti-parallel with each other, and one of the magnetic recording regions is opposite to the fixed magnetization layer with the non-magnetic layer therebetween.

According to another aspect of an embodiment, a magnetic memory device having a magnetoresistance effect element and an electrical current application means is provided. The magnetoresistance effect element includes a free magnetic layer formed in a laminate including a fixed magnetization layer having a fixed magnetization direction, a non-magnetic layer formed on the fixed magnetization layer, a first ferromagnetic layer, a non-magnetic metallic layer formed on the first ferromagnetic layer, and a second ferromagnetic layer formed on the non-magnetic metallic layer. The free magnetic layer includes magnetic recording regions, and in each region, the first ferromagnetic layer and the second ferromagnetic layer are coupled such that their magnetization directions are anti-parallel with each other, and one of the magnetic recording regions is opposite to the fixed magnetization layer with the non-magnetic layer therebetween. The electrical current application means applies an electrical current between the fixed magnetization layer and the free magnetic layer with the non-magnetic layer therebetween.

### BRIEF DESCRIPTION OF THE DRAWINGS

FIGS. 1A and 1B illustrate a schematic cross sectional view and a plane view respectively illustrating a structure of a magnetoresistance effect element according to a first embodiment;

FIGS. 2A, 2B, and 2C illustrate operation of the magnetoresistance effect element according to the first embodiment;

FIG. 3 illustrates a model for explaining an effect of the magnetoresistance effect element according to the first embodiment;

FIGS. 4A and 4B illustrate a schematic cross sectional view and a plane view respectively illustrating a structure of a magnetic memory device according to a second embodiment;

FIGS. 5A and 5B illustrate a write method in the magnetic memory device according to the second embodiment;

FIGS. 6A, 6B, and 6C are process cross sectional views (part 1) illustrating the write method in the magnetic memory device according to the second embodiment;

FIGS. 7A, and 7B are process cross sectional views (part 2) illustrating the write method in the magnetic memory device according to the second embodiment; and

FIGS. 8A, and 8B are process cross sectional views (part 3) illustrating the write method in the magnetic memory device according to the second embodiment.

### DESCRIPTION OF THE PREFERRED EMBODIMENTS

### First Embodiment

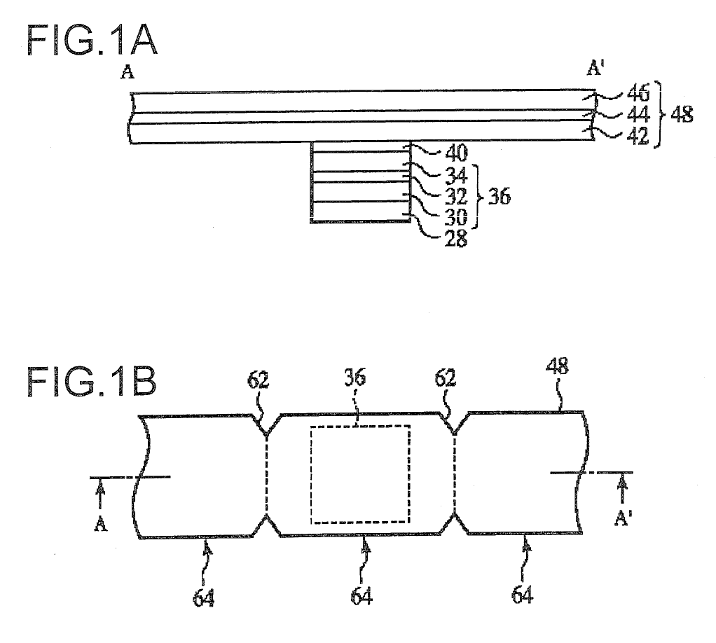

A magnetoresistance effect element according to a first embodiment is described with reference to FIGS. 1A to 3.

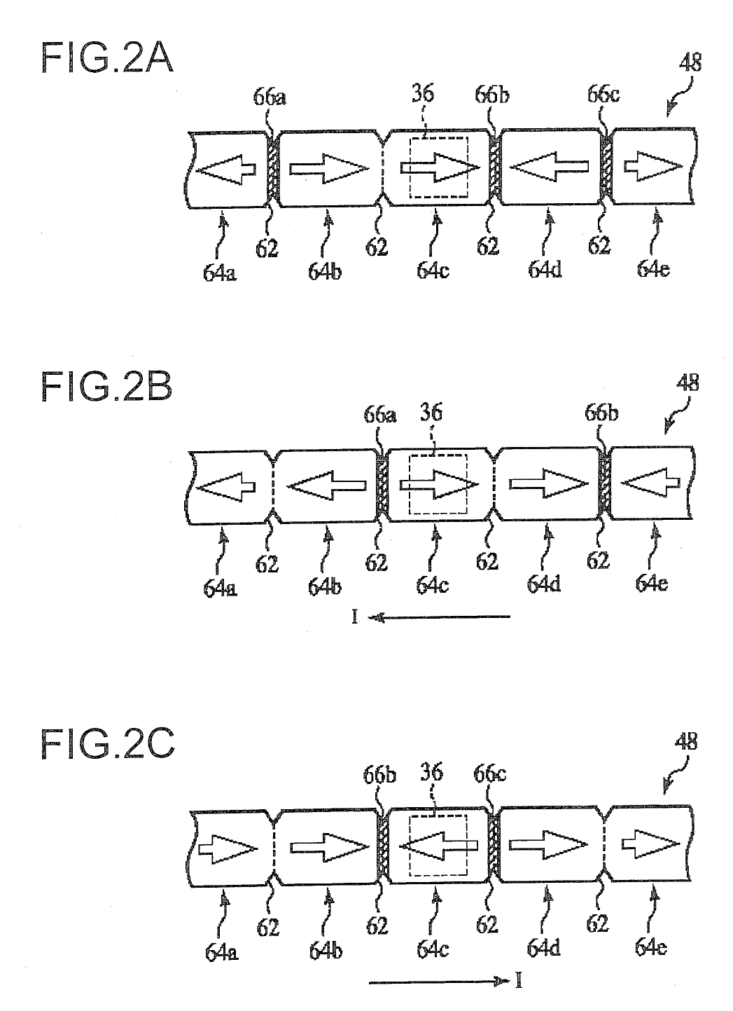

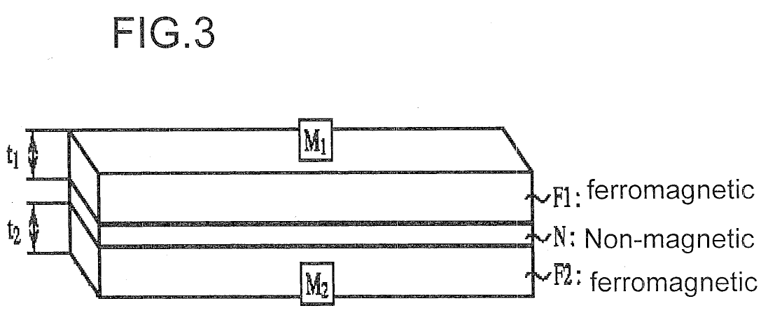

FIGS. 1A and 1B illustrate a schematic cross sectional view and a plane view respectively illustrating a structure of a magnetoresistance effect element according to the first embodiment. FIGS. 2A, 2B, and 2C illustrate operation of the magnetoresistance effect element according to the first embodiment. FIG. 3 illustrates a model for explaining an effect of the magnetoresistance effect element according to the first embodiment.

Now, the structure of the magnetoresistance effect element according to the first embodiment is described with reference to FIGS. 1A and 1B. FIG. 1A is a schematic cross sectional view illustrating the structure of the magnetoresistance effect element according to the present embodiment, and FIG. 1B is a plane view. The cross sectional view taken along the line 1B-1B corresponds to FIG. 1A.

As shown in FIG. 1A, on an anti-ferromagnetic layer 28, a ferromagnetic layer 30, a non-magnetic metallic layer 32, and a ferromagnetic layer 34 are layered to form a fixed magnetization layer 36. The fixed magnetization layer 36 is formed in a laminate of a synthetic ferromagnetic structure. On the fixed magnetization layer 36, a barrier insulation film 40 is formed. On the barrier insulation film 40, a ferromagnetic layer 42, a non-magnetic metallic layer 44, and a ferromagnetic layer 46 are layered to form a ferromagnetic fine wire 48 in a laminate.

On the ferromagnetic fine wire 48, as shown in FIG. 1B, notched parts (hereinafter, referred to as notches 62) are formed. The notches 62 are formed at positions opposite with each other such that widths (cross sectional areas) of the ferromagnetic fine wire 48 are narrowed. Moreover, the notches 62 are provided at equal intervals in an extending direction of the ferromagnetic fine wire 48. In the description, the region at which the notch 62 is formed is referred to as a regulation region, and the portion having a wide width between the notches 62 is referred to as a magnetic recording region 64.

The fixed magnetization layer 36 is disposed at a central part of the magnetic recording region 64. At a part of the magnetic recording region 64 opposite to the fixed magnetization layer 36, in conjunction with the fixed magnetization layer 36, a magnetoresistance effect can be obtained. The part corresponds to free magnetization layers in common magnetoresistance effect elements. Accordingly, in the description, the whole of the ferromagnetic fine wire 48 is also simply referred to as a free magnetization layer.

As described above, the magnetoresistance effect element according to the present embodiment includes two ferromagnetic layers layered opposite to each other with the barrier insulation film therebetween. One of the two ferromagnetic layers is the ferromagnetic fine wire. The ferromagnetic fine wire 48 is formed in the laminate including the ferromagnetic layer 42, the non-magnetic metallic layer 44, and the ferromagnetic layer 46. The ferromagnetic layer 42 and the ferromagnetic layer 46 are coupled such that their magnetization directions are anti-parallel with each other.

The anti-ferromagnetic layer 28 may be formed of, for example, an anti-ferromagnetic material that includes one of Re, Ru, Rh, Pd, IrPt, Cr, Fe, Ni, Cu, Ag, and Au, and Mn, for example, PtMn, PdPtMn, IrMn, RhMn, RuMn, FeMn, or the like.

The ferromagnetic layers 30, 34, 42, and 46 that form the fixed magnetization layer 36 and the ferromagnetic fine wire 48 may be formed of, for example, a ferromagnetic alloy material that includes one of Co, Fe, and Ni, for example, CoₓFe₁₀₀₋ₓ (0≦x≦100), NiₓFe₁₀₀₋ₓ (0≦x≦100), an amorphous material, for example, CoFeB, CoFeNi, CoFeNiB, CoFeSi, or CoFeBSi, or a half-metal material represented by A₂BC (A=Co, Fe, or Ni, B=Mn or Cr, and C=Al, Si, Ge, Sn, or V).

The non-magnetic metallic layers 32 and 44 may be formed of, for example, a non-magnetic metallic material such as Ru, Rh, Cr, or the like.

The barrier insulation film 40 may be formed of, for example, an oxide material that includes one of Mg, Al, Hf, Ti, V, Ta, or Si, or an oxynitriding material or a nitride material such as MgO, AlO, AlN, HfO, TiO, VO, TaO, SiO, or the like.

Now, basic operation of the magnetoresistance effect element according to the present embodiment is described with reference to FIGS. 2A, 2B, and 2C. In the following description, a magnetization direction of the fixed magnetization layer 36 denotes a magnetization direction of the ferromagnetic layer 34, and a magnetization direction of the ferromagnetic fine wire 48 denotes a magnetization direction of the ferromagnetic layer 42 in the magnetic recording region 64 that is opposite to the fixed magnetization layer 36. This definition has been made in consideration that a resistance state of the magnetoresistance effect element is regulated by a relationship between the magnetization direction of the ferromagnetic layer 34 and the magnetization direction of the ferromagnetic layer 42 in the magnetic recording region 64 that is opposite to the fixed magnetization layer 36.

As shown in FIG. 2A, magnetic recording regions 64a, 64b, 64c, 64d, and 64e are provided on the ferromagnetic fine wire, and it is assumed that magnetization directions of the magnetic recording regions 64a, 64b, 64c, 64d, and 64e are leftward, rightward, rightward, leftward, and rightward respectively on the drawing. Magnetic domain walls 66a, 66b, and 66c are formed between the magnetic recording region 64a and the magnetic recording region 64b; the magnetic recording region 64c and the magnetic recording region 64d; and the magnetic recording region 64d and the magnetic recording region 64e respectively in a state that the magnetization directions of the magnetic recording regions are opposite to each other respectively. It is noted that it is a common characteristic of ferromagnetic materials that their magnetization directions are opposite to each other with a magnetic domain wall therebetween. It is assumed that the fixed magnetization layer 36 is provided on the magnetic recording region 64c.

In a state shown in FIG. 2A, if an electrical current is applied in an existing direction of the ferromagnetic fine wire 48, the magnetic domain walls 66a, 66b, and 66c move in a direction electron spin flows.

For example, in FIG. 2B, if an electrical current I is applied in a left direction in the drawing, the electron spin flows in a right direction. Then, by the spin torque, the magnetic domain walls 66a, 66b, and 66c move to the right side respectively. On the other hand, in FIG. 2C, if the electrical current I is applied in a right direction in the drawing, the electron spin flows in a left direction. Then, by the spin torque, the magnetic domain walls 66a, 66b, and 66c move to the left side respectively.

In such a state, it is possible to control the moving distance of the magnetic domain walls 66 by appropriately controlling a current pulse to be applied to the ferromagnetic fine wire 48. At the portions where the notches 62 are formed, the cross sectional areas of the ferromagnetic fine wire 48 are reduced. The portions where the cross sectional areas of the ferromagnetic fine wire 48 are reduced are energetically stable as compared to portions where cross sectional areas of the ferromagnetic fine wire 48 are large. Accordingly, the magnetic domain walls 66 can be trapped at the portions where the cross sectional areas are reduced by the notches 62. That is, the notches 62 are so-called magnetic domain wall pinning sites. With the structure, the magnetic domain walls 66 can be accurately moved at portions between the magnetic recording regions 64. FIGS. 2B and 2C illustrate states that the magnetic domain walls 66 are moved by one region of the magnetic recording region 64 to the right and left respectively.

Providing the notches 62 on the ferromagnetic fine wire 48 enables to regulate the displacement of the magnetic domain walls 66. Accordingly, it is possible to increase the operation reliability in writing and reading. It is noted that the form of the notches 62 is not limited to the V shape shown in the drawings, various shapes such as a trapezoid, rectangle, or semicircle can be employed because similar effect to the above can be obtained. Accordingly, the shape of the notches 62 can be freely selected depending on the device structure.

In moving the magnetic domain walls 66 by the spin torque, the magnetization information at the magnetic recording regions 64 between the magnetic domain walls 66 is maintained without change. That is, the magnetization information (magnetization directions) recorded at each magnetic recording region 64 can be moved without change to an adjacent magnetic recording region 64 respectively along the moving direction of the magnetic domain walls 66 in conjunction with the displacement of the magnetic domain walls 66.

As described above, by moving the magnetic domain walls 66 along the extending direction of the ferromagnetic fine wire 48, the magnetization information recorded in any magnetic recording region 64 can be moved to the magnetic recording region 64 corresponding to the portion opposite to the fixed magnetization layer 36. Accordingly, the magnetization information recorded in any magnetic recording region 64 can be read out.

That is, for example, in a case where the magnetization direction of the fixed magnetization layer 36 is rightward in the drawing, if a state after the magnetic domain walls 66 are moved is a state shown in FIG. 2A or 2B, the magnetization direction of the fixed magnetization layer 36 and the magnetization direction of the magnetic recording region 64c are parallel with each other, and an element resistance between the fixed magnetization layer 36 and the magnetic recording region 64c is low. On the other hand, if a state after the magnetic domain walls 66 are moved is a state shown in FIG. 2C, the magnetization direction of the fixed magnetization layer 36 and the magnetization direction of the magnetic recording region 64c are anti-parallel with each other, and the element resistance between the fixed magnetization layer 36 and the magnetic recording region 64c is high. Accordingly, a voltage corresponding to the resistance state of the magnetoresistance effect element is output by applying a read current on the magnetoresistance effect element in a perpendicular direction, that is, between the ferromagnetic fine wire 48 and the fixed magnetization layer 36 with the barrier insulation film 40 therebetween. By detecting the voltage, it is possible to read out whether the magnetoresistance effect element is in the high resistance state or the low resistance state, that is, data “0” is recorded or data “1” is recorded.

As described above, the magnetoresistance effect element according to the present embodiment utilizes the displacement of the magnetic domain walls 66 in the ferromagnetic fine wire 48 generated by the electron spin injection. In the magnetoresistance effect element, the ferromagnetic fine wire 48 is formed in the laminate including the ferromagnetic layer 42, the non-magnetic metallic layer 44, and the ferromagnetic layer 46. The ferromagnetic layer 42 and the ferromagnetic layer 46 are coupled such that their magnetization directions are anti-parallel with each other. With the structure of the magnetoresistance effect element, it is possible to increase the displacement speed of the magnetic domain walls without decreasing the stability to thermal fluctuation.

Now, the above-described effect of the magnetoresistance effect element is described in detail. A saturation magnetization Mₛ of a ferromagnetic fine wire as a whole in a three-layer ferromagnetic fine wire is described. As shown in FIG. 3, the ferromagnetic fine wire includes a ferromagnetic layer F₁ having a thickness t₁, and a saturation magnetization M₁, and a ferromagnetic layer F₂ having a thickness t₂ (≠t₁), and a saturation magnetization M₂ with a non-magnetic metallic layer N therebetween, and the ferromagnetic layer F₁ and the ferromagnetic layer F₂ are coupled to have anti-parallel magnetization directions. In the following description, the laminated film in which the magnetization directions of the two ferromagnetic layers are anti-parallel with each other is referred to as an anti-parallel coupled film.

If the ferromagnetic layer F₁ and the ferromagnetic layer F₂ are coupled to have anti-parallel magnetization directions with a non-magnetic metallic layer N therebetween, an apparent saturation magnetization Mₛ can be represented as follows:

Mₛ=|t₁M₁−t₂M₂|/(t₁+t₂) (1)

That is, since the magnetization directions of the ferromagnetic layer F₁ and the ferromagnetic layer F₂ are anti-parallel with each other, the apparent magnetizations are negated, and an effective magnetization becomes smaller than that in a case of a single layer (for example, see T. Nozaki et al., “Magnetic switching properties of magnetic tunnel junctions using a synthetic ferrimagnet free layer”, J. Appl. Phys., Vol. 95, 2004, pp. 3745-3748).

It is noted that since the thickness of the non-magnetic metallic layer N layered between the ferromagnetic layer F₁ and the ferromagnetic layer F₂ is extremely thin that affection to the magnetization Mₛ is small enough to neglect.

Meanwhile, it has been known that a magnetic domain wall displacement speed v according to the electron spin injection is represented according to a relationship between variations of magnetic moments due to a spin transfer effect and magnetic domain wall displacement as follows (for example, see A. Yamaguchi et al., “Real space observation of current-driven domain wall motion in submicron magnetic wires”, Phys. Rev. Lett., Vol. 92, 2004, pp. 077205-1-077205-4).

v=(_{μB}P/eMₛ)j (2)

wherein, _{μB} denotes Bohr magneton, e denotes elementary charge of electron, P denotes spin polarizability of magnetic material, and j denotes current density.

As is clear from the equation (2), the magnetic domain wall displacement speed v is proportional to the current density j, and inversely proportional to the saturation magnetization Mₛ. Accordingly, to increase the magnetic domain wall displacement speed, it is necessary to increase the current density j, or decrease the saturation magnetization Mₛ.

Between the conditions, it is not preferred to increase the current density j because the increase of the current density j requires increase in power consumption. Moreover, it is not also preferred to decrease the saturation magnetization Mₛ too much because if the saturation magnetization Mₛ is too small, the thermal stability is decreased.

However, the anti-parallel coupled film shown in FIG. 3 can realize high thermal stability as compared to a single-layer ferromagnetic film (for example, see Ikeda et al., “proceeding of the 67th Japan Society of Applied Physics autumn meeting” (2006, Autumn), 29p-ZK-11). Accordingly, the magnetic domain wall displacement speed v can be increased using the anti-parallel coupled film to reduce the saturation magnetization Mₛ while high thermal stability is ensured. Moreover, with respect to the thermal fluctuation considered in a case that the ferromagnetic fine wire is miniaturized, it is expected that the stability is increased.

As understood from the above description, it is preferred that the saturation magnetizations (materials) and the thicknesses of the ferromagnetic layers 42 and 46 that form the ferromagnetic fine wire 48 are set so that the value of the effective saturation magnetizations Mₛ of the ferromagnetic fine wire 48 as a whole is to be as small as possible.

Now, it is assumed that an anti-parallel coupled film includes two ferromagnetic layers F₁ and F₂ formed of a same material (that is, M_{S}=M₁=M₂), and the thickness of the ferromagnetic layer F₁ is t₁=30 nm, and the thickness of the ferromagnetic layer F₂ is t₂=20 nm (t₁+t₂=50 nm). Moreover, it is assumed that a single-layer ferromagnetic film is formed of the same material forming the ferromagnetic layers F₁ and F₂, and has a thickness of 50 nm.

In a case where a saturation magnetization of the anti-parallel coupled film is M_{sy}, and a saturation magnetization of the single-layer ferromagnetic film is M_{single}, if the saturation magnetization M_{sy} is compared with the saturation magnetization M_{single}, a result is given as follows.

M_{sy}/M_{single}=(|30×Mₛ−20×Mₛ|/50)/Mₛ=1/5

Accordingly, the saturation magnetization M_{sy} of the anti-parallel coupled film is apparently one fifth of the saturation magnetization M_{single} of the single-layer ferromagnetic film. Therefore, according to the equation (2), a magnetic domain wall displacement speed at this case can be estimated to be five times of that of the single-layer film.

As described above, according to the present embodiment, the magnetoresistance effect element includes two ferromagnetic layers layered opposite to each other with the barrier insulation layer therebetween. One of the two ferromagnetic layers is the ferromagnetic fine wire, and the ferromagnetic fine wire is formed in the laminate including the ferromagnetic layer, the non-magnetic metallic layer, and the ferromagnetic layer. The ferromagnetic layers are coupled such that their magnetization directions are anti-parallel with each other. Accordingly, the magnetization of the ferromagnetic fine wire can be stabilized, the saturation magnetization of the ferromagnetic fine wire as a whole can be reduced, and thereby the displacement speed of the magnetic domain walls can be increased without reducing stability to thermal fluctuation.

### Second Embodiment

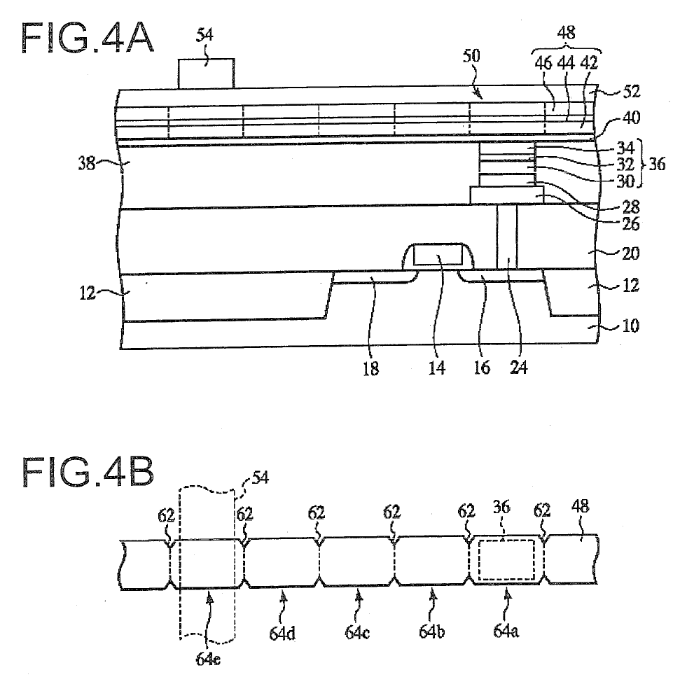

A magnetic memory device and a manufacturing method of the device according to a second embodiment will be described with reference to FIGS. 4A to 8B. To elements similar to those in the magnetoresistance effect element according to the first embodiment shown in FIGS. 1A to 3, the same reference numerals are applied and their descriptions are omitted or simplified.

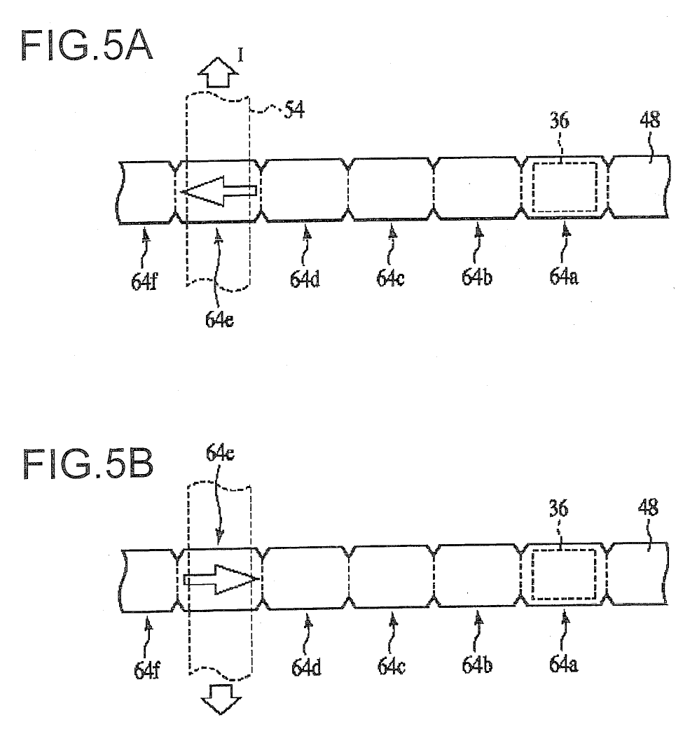

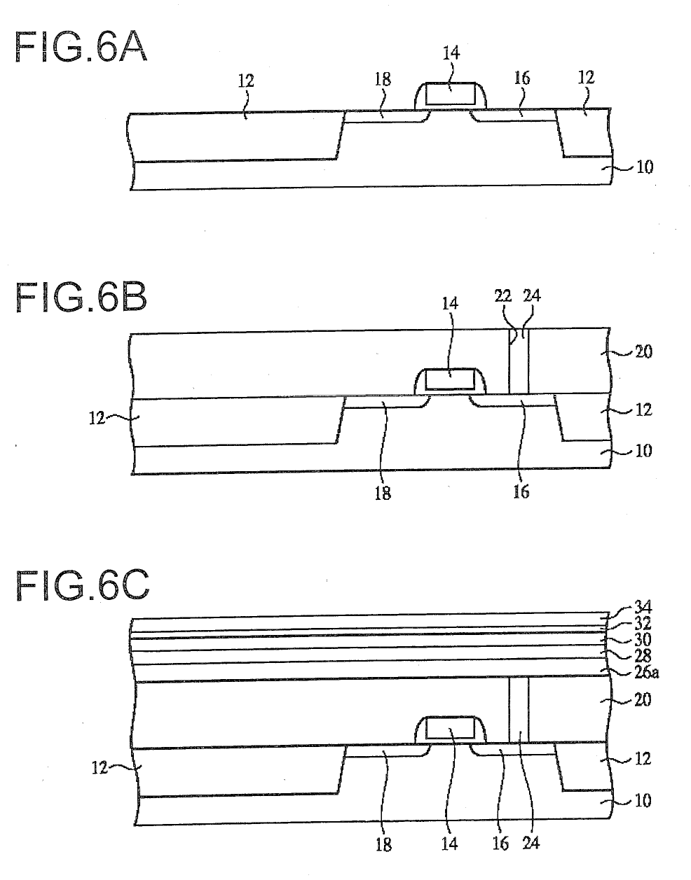

FIGS. 4A and 4B illustrate a schematic cross sectional view and a plane view respectively illustrating a structure of a magnetic memory device according to the second embodiment. FIGS. 5A and 5B illustrate a write method in the magnetic memory device according to the second embodiment. FIGS. 6A to 8B are process cross sectional views illustrating manufacturing methods of the magnetic memory device according to the second embodiment.

A structure of the magnetic memory device according to the second embodiment is described with reference to FIGS. 4A and 4B.

On a silicon substrate 10, an element isolation film 12 that defines an active region is formed. In the active region defined by the element isolation film 12, a selection transistor that includes a gate electrode 14 and source/drain regions 16 and 18 is formed.

On the silicon substrate 10 on which the selection transistor is formed, an interlayer insulation film 20 is formed. In the interlayer insulation film 20, a contact plug 24 that is connected to the source/drain region 16 is embedded.

On the interlayer insulation film 20 in which the contact plug 24 is embedded, a lower electrode layer 26, an anti-ferromagnetic layer 28 formed on the lower electrode layer 26, and the fixed magnetization layer 36 formed on the anti-ferromagnetic layer 28 are formed. The lower electrode layer 26 is electrically connected to the source/drain region 16 through the contact plug 24. The fixed magnetization layer 36 includes the ferromagnetic layer 30, the non-magnetic metallic layer 32, and the ferromagnetic layer 34, and the fixed magnetization layer 36 is formed in the laminate of a synthetic ferromagnetic structure. On a region of the interlayer insulation film 20 other than the region where the lower electrode layer 26, the anti-ferromagnetic layer 28, and the fixed magnetization layer 36 are formed, an interlayer insulation film 38 is formed.

On the interlayer insulation film 38, the barrier insulation film 40 is formed. On the barrier insulation film 40, the ferromagnetic fine wire 48 formed in the laminate of the synthetic ferromagnetic structure including the ferromagnetic layer 42, the non-magnetic metallic layer 44, and the ferromagnetic layer 46 is formed. To the ferromagnetic fine wire 48, as shown in FIG. 4B, the notches 62 are formed at equal intervals. By the notches 62, the magnetic recording regions 64a, 64b, 64c, 64d, 64e, . . . are defined. One of the magnetic recording regions (magnetic recording region 64a) is opposite to the fixed magnetization layer 36 with the barrier insulation film 40 therebetween.

On the barrier insulation film 40 on which the ferromagnetic fine wire 48 is formed, the interlayer insulation film 52 is formed. On the interlayer insulation film 52, a write wire 54 is formed. The write wire 54 is, as shown in FIG. 4B, disposed on one of the magnetic recording regions (magnetic recording region 64e) of the ferromagnetic fine wire 48 so that the write wire 54 is orthogonal to the magnetic recording region.

As described above, the magnetic memory device according to the present embodiment is formed using the magnetoresistance effect element according to the first embodiment.

Now, a write method for the magnetic memory device according to the present embodiment is described with reference to FIGS. 5A and 5B.

For the write in the magnetic memory device according to the present embodiment, the write wire 54 is used.

As shown in FIG. 5A, if an electrical current I is applied to the write wire 54 in an upward direction in the drawing, to the magnetic recording region 64e, an external magnetic field is applied in a leftward direction in the drawing. Then, a magnetization direction of the magnetic recording region 64e turns to the left in conjunction with the external magnetic field.

On the other hand, as shown in FIG. 5B, if the electrical current I is applied to the write wire 54 in an downward direction in the drawing, to the magnetic recording region 64e, an external magnetic field is applied in a rightward direction in the drawing. Then, the magnetization direction of the magnetic recording region 64e turns to the right in conjunction with the external magnetic field.

It is noted that in the magnetoresistance effect elements such as the magnetoresistance effect element according to the first embodiment in which the ferromagnetic layer 42 and the ferromagnetic layer 46 are coupled to be anti-parallel with each other, the effective magnetization direction of the magnetic recording region 64e as a whole viewed from outside turns in conjunction with the external magnetic field.

To write in the magnetic memory device, in addition to the above-described external magnetic field application method, other write methods using a mechanism of spin injection magnetization reversal can be used. If the spin injection magnetization reversal method is used, it is possible to reverse a magnetization direction of the magnetic recording region 64 that is opposite to the fixed magnetization layer 36 in any direction by applying a write current of a predetermined direction between the ferromagnetic fine wire 48 and the fixed magnetization layer 36.

That is, the application of the write current from the side of the fixed magnetization layer 36 to the side of the magnetic recording region 64 generates the magnetization reversal in the ferromagnetic layers 42 and 46 such that the magnetization directions of the ferromagnetic layer 34 of the fixed magnetization layer 36 and the ferromagnetic layer 42 of the magnetic recording region 64 are anti-parallel with each other. On the other hand, the application of the write current from the side of the magnetic recording region 64 to the side of the fixed magnetization layer 36 generates the magnetization reversal in the ferromagnetic layers 42 and 46 such that the magnetization directions of the ferromagnetic layer 34 of the fixed magnetization layer 36 and the ferromagnetic layer 42 of the magnetic recording region 64 are parallel with each other.

The current density of the current applied for the spin injection magnetization reversal is smaller than that applied for the magnetic domain wall displacement by about single digit. Accordingly, the magnetization directions in the magnetic recording regions can be reversed without displacement of the magnetic domain walls.

With the above-described method, after the write of the magnetization information in the magnetic recording region 64e is finished, a current is applied to the ferromagnetic fine wire 48 to displace the magnetic domain walls. That is, the magnetization information recorded in the magnetic recording region 64e is displaced to the adjacent magnetic recording region 64d or 64f.

By repeatedly performing the steps, predetermined magnetization information can be sequentially written in the magnetic recording regions on the ferromagnetic fine wire 48.

With respect to the read method for the magnetic memory device according to the present embodiment is similar to that for the magnetoresistance effect element according to the first embodiment.

Now, a manufacturing method of the magnetic memory device according to the present embodiment is described with reference to FIGS. 6A to 8B.

First, on the silicon substrate 10, for example, using shallow trench isolation (STI), the element isolation film 12 that defines an active region is formed.

Then, on the active region defined by the element isolation film 12, in a similar way to common formation methods of MOS transistors, a selection transistor that has the gate electrode 14 and the source/drain regions 16 and 18 is formed (FIG. 6A).

On the silicon substrate 10 on which the selection transistor has been formed, a silicon oxide film is deposited using, for example, chemical vapor deposition (CVD), the surface is planarized by chemical mechanical polishing (CMP), and thereby the interlayer insulation film 20 formed of the silicon oxide film is formed.

Then, by photolithography or dry etching, in the interlayer insulation film 20, a contact hole 22 that reaches to the source/drain region 16 is formed.

Then, for example, by CVD, a titanium nitride film and a tungsten film as barrier metals are deposited, the conductive films are etch-backed or polish-backed, and thereby a contact plug 24 that is embedded in the contact hole 22 and electrically connected to the source/drain region 16 is formed (FIG. 6B).

On the interlayer insulation film 20 in which the contact plug 24 is embedded, for example, by a sputtering method, a conductive layer 26a formed of a conductive material, for example, Ta having a film thickness of 5 nm, the anti-ferromagnetic layer 28 formed of an anti-ferromagnetic material, for example, PtMn having a film thickness of 10 nm, the ferromagnetic layer 30 formed of a ferromagnetic material, for example, CoFe having a film thickness of 2 nm, the non-magnetic layer 32 formed of a non-magnetic material, for example, Ru having a film thickness of 0.7 nm, and the ferromagnetic layer 34 formed of a ferromagnetic material, for example, CoFeB having a film thickness of 3 nm are sequentially formed (FIG. 6C).

Then, by photolithography or dry etching, the ferromagnetic layer 34, the non-magnetic metallic layer 32, the ferromagnetic layer 30, and the anti-ferromagnetic layer 28 are patterned, and thereby the fixed magnetization layer 36 that is formed in the laminate of the synthetic ferromagnetic structure including the ferromagnetic layer 34, the non-magnetic metallic layer 32, and the ferromagnetic layer 30 is formed.

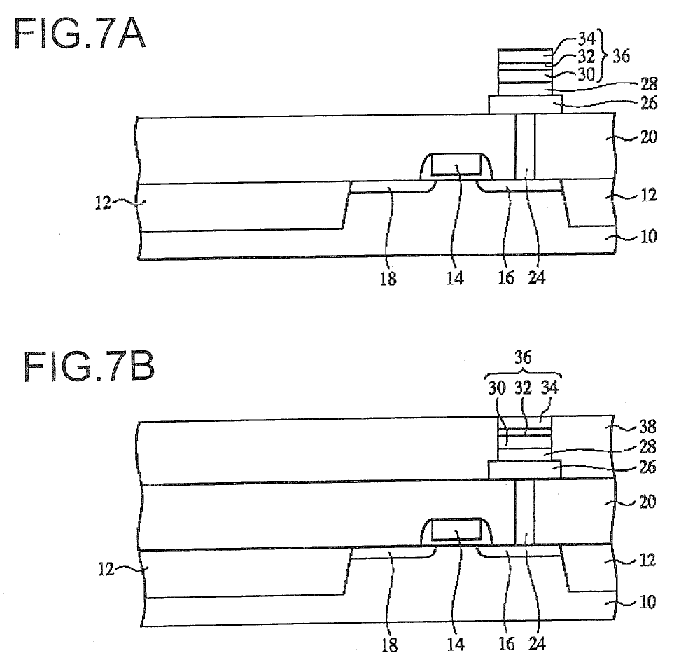

Then, by photolithography or dry etching, the conductive film 26a is patterned and the lower electrode layer 26 formed of the conductive film 26a is formed (FIG. 7A).

On the interlayer insulation film 20 on which the lower electrode layer 26, the anti-ferromagnetic layer 28, and the fixed magnetization layer 36 have been formed, for example, by CVD, a silicone oxide film is deposited, the surface is polished until the fixed magnetization layer 36 is exposed by CMP, and thereby the interlayer insulation film 38 that is formed of the silicon oxide film is formed (FIG. 7B).

On the interlayer insulation film 38 in which the fixed magnetization layer 36 is embedded, for example, by a sputtering method, an insulation material, for example, MgO having a film thickness of 1 nm, is deposited, and thereby the barrier insulation film 40 that is formed of the insulation material is formed.

On the barrier insulation film 40, for example, by a sputtering method, the ferromagnetic layer 42 that is formed of a ferromagnetic material, for example, CoFe having a film thickness of 20 nm, the non-magnetic metallic layer 44 that is formed of a non-magnetic metallic material, for example, Ru having a film thickness of 0.7 nm, and the ferromagnetic layer 46 that is formed of a ferromagnetic material, for example, CoFe having a film thickness of 30 nm are sequentially formed.

By photolithography or dry etching, the ferromagnetic layer 46, the non-magnetic metallic layer 44, and the ferromagnetic layer 42 are patterned and thereby the ferromagnetic fine wire 48 that is formed in the laminate of the synthetic ferromagnetic structure including the ferromagnetic layer 46, the non-magnetic metallic layer 44, and the ferromagnetic layer 42 is formed.

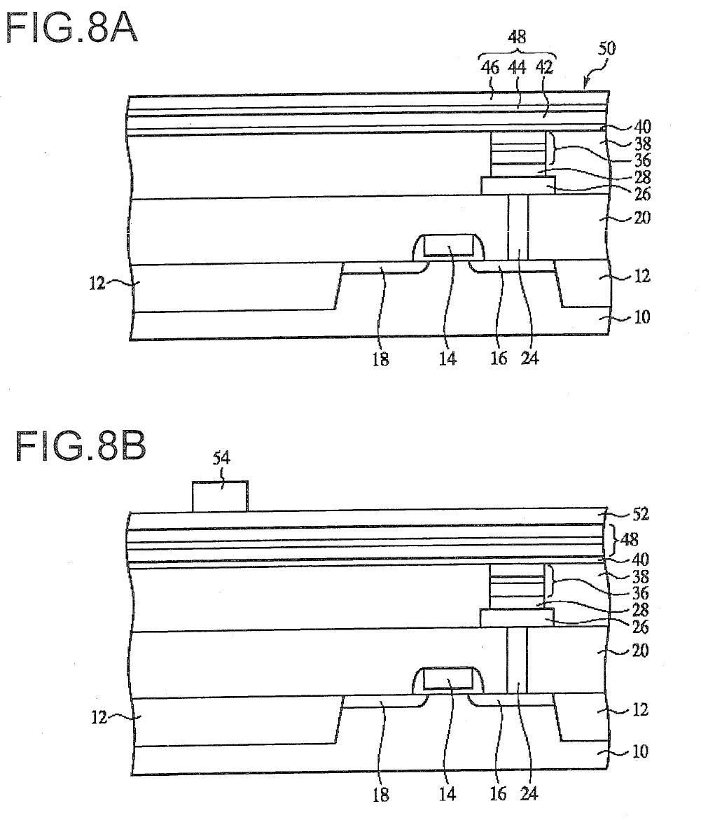

As described above, a magnetoresistance effect element 50 formed in a TMR structure that includes the anti-ferromagnetic layer 28, a fixed magnetization layer 36, the barrier insulation film 40, and the ferromagnetic fine wire 48 is formed (FIG. 8A).

On the barrier insulation film 40 on which the magnetoresistance effect element 50 has been formed, a silicon oxide film is deposited, for example, by CVD, the surface is planarized by CMP, and thereby an interlayer insulation film 52 formed of the silicon oxide film is formed.

Then, on the interlayer insulation film 52, a conductive film is deposited and patterned, and the write wire 54 is formed (FIG. 8B).

Thereafter, an insulation layer, a wiring layer, or the like is further formed on the upper layer if necessary, and then the formation of the magnetic memory device according to the present embodiment is finished.

As described above, according to the present embodiment, the magnetic memory device is formed using the magnetoresistance effect element according to the first embodiment, and it is possible to increase the displacement speed of the magnetic domain walls without decreasing the stability to thermal fluctuation of the magnetoresistance effect element. Accordingly, it is possible to increase the write speed, the read speed, and the operation reliability of the magnetic memory device.

### Modified Embodiments

The present invention is not limited to the above-described embodiments, but various modifications may be made.

For example, the structural materials of the magnetoresistance effect element described in the above embodiments are typical structural materials, and these are not limited to the above.

In the above-described embodiments, the fixed magnetization layer is formed in the synthetic ferromagnetic structure of CoFeB/Ru/CoFe to decrease the magnetic leakage magnetic field from the fixed magnetization layer 36. However, using the above-described materials, a single-layer fixed magnetization layer may be formed.

In the above-described embodiments, the regulation regions for regulating the displacement of the magnetic domain walls are formed by the notches. However, as described in the specification of Japanese Patent Application No. 2006-151180 by the inventors of the present invention, the regulation regions may be formed by selectively irradiating an ion beam on a ferromagnetic fine wire and selectively changing a magnetic property of a ferromagnetic material.

In the above-described embodiments, the present invention is applied to the magnetic memory device having the TMR type magnetoresistance effect element. However, the present invention may be similarly applied to a magnetic memory device having a GMR type magnetoresistance effect element. In such a case, in place of the barrier insulation film 40, a conductive non-magnetic layer may be provided. However, in consideration of variation of resistance values due to a magnetoresistive effect, it is preferable to use the TMR type magnetoresistance effect element.

Moreover, the magnetoresistance effect element according to the present invention is not limited to the magnetic memory device according to the above-described second embodiment, but the magnetoresistance effect element may be applied to magnetic memory devices of various structures. With respect to the magnetic memory device using the magnetic domain wall displacement in the ferromagnetic fine wire, the inventors of the present invention have discussed in Japanese Patent Application No. 2006-093446, Japanese Patent Application No. 2006-146135, Japanese Patent Application No. 2006-149535, Japanese Patent Application No. 2006-151180, Japanese Patent Application No. 2006-151253, and the like. The magnetoresistance effect element according to the present invention may be applied to the magnetic memory devices described in these applications.

According to the present invention, in the magnetoresistance effect element including two ferromagnetic layers layered opposite to each other with the non-magnetic layer therebetween in which one of the two ferromagnetic layers is a ferromagnetic fine wire, the ferromagnetic fine wire is formed in a laminate including a ferromagnetic layer, a non-magnetic metallic layer, and a ferromagnetic layer. The ferromagnetic layers are coupled such that their magnetization directions are anti-parallel with each other. Accordingly, magnetization of the ferromagnetic fine wire can be stabilized, saturation magnetization of the ferromagnetic fine wire as a whole can be reduced, and thereby a displacement speed of magnetic domain walls can be increased without reducing stability to thermal fluctuation. Further, using such a magnetoresistance effect element, a magnetic memory device utilizing a magnetic domain wall displacement phenomenon and a magnetoresistance effect in the fine wire ferromagnetic layers is formed. Accordingly, it is possible to increase a write speed and a read speed in the magnetic memory device and also increase operation reliability.

What is claimed is:

1. A magnetoresistance effect element comprising:
a fixed magnetization layer having a fixed magnetization direction;
a non-magnetic layer formed on the fixed magnetization layer; and
a free magnetic layer having a laminate structure,
wherein the laminate structure includes a first ferromagnetic layer, a non-magnetic metallic layer formed over the first ferromagnetic layer, and a second ferromagnetic layer formed over the non-magnetic metallic layer,
wherein the free magnetic layer has magnetic recording regions, the first ferromagnetic layer and the second ferromagnetic layer are coupled in each of the magnetic recordings region such that their magnetization direction are anti-parallel with each other, and one of the magnetic recording regions is opposite to the fixed magnetization layer with the non-magnetic layer therebetween.

2. The magnetoresistance effect element according to claim 1, wherein the free magnetic layer comprises regulation regions for regulating the displacement of the magnetic domain walls which are formed at regular intervals, and the regulation regions defines the magnetic recording regions.

3. The magnetoresistance effect element according to claim 1, wherein the non-magnetic layer comprises a insulation material.

4. A magnetic memory device comprising:
a magnetoresistance effect element having a fixed magnetization layer having a fixed magnetization direction, a non-magnetic layer formed on the fixed magnetization layer; and a free magnetic layer is formed in a laminate structure, wherein the laminate structure includes a first ferromagnetic layer, a non-magnetic metallic layer formed over the first ferromagnetic layer, and a second ferromagnetic layer formed over the non-magnetic metallic layer,
wherein the free magnetic layer has magnetic recording regions, the first ferromagnetic layer and the second ferromagnetic layer are coupled in each of the magnetic recordings region such that their magnetization direction are anti-parallel with each other, and one of the magnetic recording regions is opposite to the fixed magnetization layer with the non-magnetic layer therebetween.
a electrical current application means which applies an electrical current between the fixed magnetization layer and free magnetic layer with the non-magnetic layer therebetween.

5. A magnetic memory device according to claim 4 further comprising:
a magnetic domain wall moving means which moves the magnetic domain wall between the magnetic recording regions by applying the electrical current in an existing direction of the free magnetic layer.

6. A magnetic memory device according to claim 5 further comprising:
a writing means which writes a magnetization information in the magnetic recording regions.

7. A magnetic memory device according to claim 6, wherein the writing means writes the magnetization information by applying a external magnetic field to the magnetic recording regions.

8. A magnetic memory device according to claim 6, wherein the writing means writes the magnetization information by the spin injection by applying a current between the fixed magnetization layer and the free magnetic layer.
